(19) United States
(12) Patent Application Publication
(10) Pub. No.: US 2015/0375903 A1
(43) Pub. Date: Dec. 31, 2015

(54) PRIVACY BAG FOR VIBRATORS, DILDOS, AND/OR OTHER SEX TOYS

(71) Applicants: Sally Lomax Mallett, Houston, TX (US); Rita Jauregui de Kuri, Houston, TX (US)

(72) Inventors: Sally Lomax Mallett, Houston, TX (US); Rita Jauregui de Kuri, Houston, TX (US)

(21) Appl. No.: 14/846,699

(22) Filed: Sep. 4, 2015

Related U.S. Application Data
(62) Division of application No. 13/952,568, filed on Jul. 26, 2013.

(51) Int. Cl. B65D 33/25; B65D 85/00; A61H 19/00; B65D 81/24

(52) U.S. Cl. CPC B65D 33/2566; B65D 81/24; B65D 85/70; A61H 19/44

(57) ABSTRACT

A privacy bag is disclosed, for the safekeeping of a vibrator, a dildo, or other sex toy. The privacy bag or sleeve is available in several different configurations, and includes interior material that is antibacterial, antistatic, anti-allergenic, water-resistant, and/or oil-resistant.

### CROSS-REFERENCE TO RELATED APPLICATIONS

This application is a continuation of U.S. Provisional Patent Application No. 61/676,183, filed on Jul. 26, 2012, the entire contents of which are hereby incorporated by reference as if fully set forth herein. This application is a divisional of U.S. patent application Ser. No. 13/952,568 filed on Jul. 26, 2013.

### TECHNICAL FIELD

This application relates to vibrators, dildos, and other products for the sex toy industry.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a depiction of a privacy bag, according to some embodiments;

FIG. 2 is a depiction of a second privacy bag, according to some embodiments;

FIGS. 3A and 3B are depictions of a third privacy bag, according to some embodiments;

FIGS. 4A and 4B are depictions of a fourth privacy bag, according to some embodiments;

FIG. 5 is a depiction of the privacy bag storing a vibrator, according to some embodiments;

FIG. 6 is a depiction of the privacy bag of FIG. 2 being used to store a dildo, according to some embodiments; and

FIG. 7 is a depiction of a privacy sleeve being used to protect a vibrator, according to some embodiments.

### DETAILED DESCRIPTION

In accordance with the embodiments described herein, a privacy bag or sleeve is disclosed, for the safekeeping of a vibrator, a dildo, or other sex toy. The privacy bag or sleeve is available in several different configurations, and includes interior material that is antibacterial, antistatic, anti-allergenic, and/or water-resistant.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

Before describing the privacy bag in detail, some terms that are used herein are defined. A dildo is defined herein as a non-vibrating toy (no power source) that often assumes a phallic (penis) shape. A vibrator is defined herein as a vibrating toy (usually has a power source). While many vibrators are phallic in shape, vibrators may assume other configurations and shapes. Dildos often emulate the human phallus while vibrators are less likely to do so. Both vibrators and dildos are referred to herein as “phallic devices,” are among a large variety of devices deemed “sex toys,” and generally encompass the realm of adult entertainment relating to sexual activity. Specific use of these sex toys is beyond the scope of this disclosure and is thus left to the imagination and further research of the reader.

Dildos and vibrators are made from a variety of materials, in many different colors and many different shapes. Typically, dildos are made from softer, elastomeric or plastic materials while vibrators feature more rigid materials. Vibrators are known to be made of hard plastic, aluminum, wood, and ceramic, while dildos are more often designed to emulate the feel of real skin as much as possible, with materials like silicon, jelly, cyberskin, futurotic, softskin, or other soft-touch materials being used.

Besides vibrators and dildos, the adult sex toy industry features beads, plugs, probes, stimulators, rings, exercisers, bondage devices, harnesses, whips, teasers, lubricants, and mounts, to name a few. The sex toys may be designed for women, men, or couples. The materials used to construct the sex toys are as varied as the types of sex toys available, and may include materials that are common in dildos and vibrators.

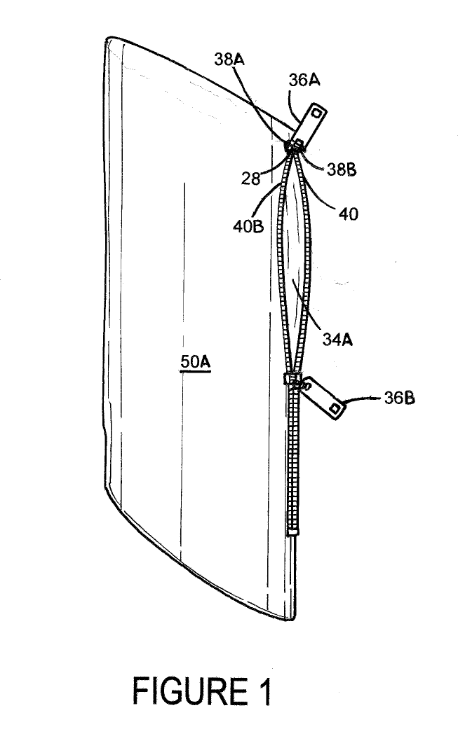

With reference to FIGS. 1-4, privacy bags 50A-50D (collectively, “privacy bags 50”) are illustrated, according to some embodiments. The privacy bags 50 are used to store sex toys, preferably after the sex toys have been cleaned. The privacy bags 50 offer both the discrete storage of sex toys and the protection against the transfer of microbes, allergens, moisture, dust and other particulates, and so on, onto the sex toy following cleaning.

Before describing each privacy bag individually, each bag commonly includes both an interior protective portion (34A-34D in FIGS. 1-4, respectively; collectively, “inner protective portion 34”) and an exterior portion (32A-32D in FIGS. 1-4, respectively; collectively, “exterior portion 32”). Although each privacy bag 50 described herein features an exterior portion 32 that is made of fabric, in other embodiments, the exterior portion 32 is made of a non-fabric, rigid material, such as plastic, wood, ceramic, metal, and so on.

FIG. 1 is a depiction of a first privacy bag 50A, according to some embodiments. The privacy bag 50A features an exterior fabric portion 32A and in interior protective portion 34A. The privacy bag 50A is to be secured in a closed position after storing the sex toy inside the privacy bag. Accordingly, in some embodiments, the closure means is a zipper. Other closure means, such as snaps, Velcro®, and buttons may alternatively be used to secure the privacy bag 50A in a shut position.

The privacy bag 50A features two zipper chains 40A and 40B that interdigitate with one another upon securing the bag (collectively, “zipper 40”). The zipper 40 features a slider 28 having an interior y-shaped channel (not shown) that causes the two zipper chains 40A and 40B to interdigitate and thus close into a single chain. The zipper 40 of FIG. 1 features two pull tabs 36A and 36B (collectively, “pull tabs 36”). Pull tabs 36A and 36B optionally include locking loop 38A and 38B respectively (collectively, “locking loops 38”). A lock (not shown) may be threaded through the locking loops 38A and 38B once the two pull tabs 36 of the zipper 40 have been joined.

Although it may be made using any of a variety of fabrics, in some embodiments, the exterior fabric portion 32A of the privacy bag 50A is made of a soft fabric, such as velvet. In some embodiments, the exterior fabric portion 32A consists of a stretch velvet fabric composed of about 80% polyester and 20% Lycra®. In some other embodiments, the exterior fabric portion 32A is made using both polyester and Spandex®. The exterior fabric portion 32A may consist of one or more of different fabric materials in a variety of combinations.

The interior protective portion 34A is made up of an anti-microbial material, in some embodiments, and may further feature anti-static, anti-bacterial, moisture-resistant, and stain-resistant characteristics. In some embodiments, the interior protective portion 34A consists of a HERCULITE® material with a urethane anti-microbial coating. HERCULITE® is a vinyl textile that, among other characteristics, is water-resistant. In other embodiments, the interior protective portion 34A consists of CHITOSANTE anti-microbial fabric. Chitosan is a polysaccharide that exhibits antibacterial properties. CHITOSANTE, the fabric made using Chitosan, also exhibits antibacterial, as well as odor-resistant, non-toxic, biodegradable, and other desirable properties. An optional attached loop 30 provides a simple means to carry the privacy bag 50A.

In some embodiments, the privacy bag 50A is approximately eight inches long and twelve inches wide. The privacy bag 50A is thus large enough to privately store vibrators, dildos, and other sex toys having a variety of shapes and sizes. With an additional lock (not shown), the privacy bag 50A offers premium storage of sex toys, enabling the toys to be out of reach of children. Without the additional lock, the privacy bag 50A is nevertheless shaped so as to obscure its contents.

The anti-microbial characteristic of the interior protective portion 34A provides protection of the sex toy by inhibiting growth of microbes on the sex toy following cleaning, thus ensuring that the sex toy is available for subsequent use. Anti-microbial agents may be added to the fabric of the interior protective portion 34A in a number of different ways. Likewise, the interior protective portion 34A may be impregnated with anti-fungal agents, moisture- and stain-resistant agents, and anti-static agents, as desired.

Persons of ordinary skill in the art will recognize a number of different ways to construct the privacy bag 50A. For example, where the privacy bag 50A is rectangular in shape, the interior protective portion 34A and the exterior fabric portion 32A may be cut to a particular rectangular size, representing a desired size of the privacy bag 50A. The two fabric portions 32A and 34A may be laid adjacent to one another, with three of the four edges of the fabric being sewn together, thus forming a pouch with an open top. The sewn fabric may then be turned inside out, such that the edge seams are on the inside of the pouch, and a zipper or other closure means may be sewn into the top of the pouch.

The optional attached loop 30 may thereafter be sewn on. For privacy bags having more unusual or atypical shape, the exterior fabric portion and interior protective portion are simply cut into the atypical shape, and the edges of the fabric are sewn together all along the atypical shape, as long as some of the edges are not sewn together, leaving an opening for either a zipper to secure the bag shut, as in the privacy bag 50A or some other means. The privacy bags 50B, 50C, and 50D, below, represent just a few other embodiments that offer similar benefits.

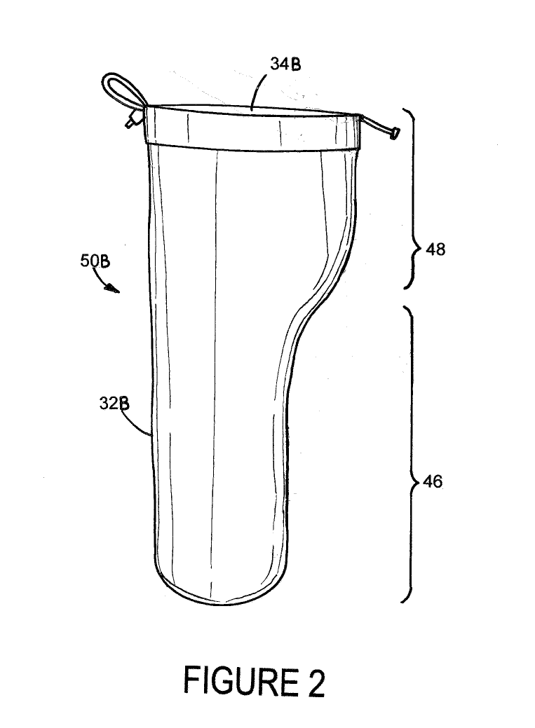

FIG. 2 is a depiction of a second privacy bag 50B, according to some embodiments. The second privacy bag 50B may also operate as a sleeve that is disposed over the sex toy. Like the privacy bag 50A, the privacy bag 50B features an interior protective portion 34B, impregnated with the anti-microbial material, as described above, and an exterior fabric portion 32B. Instead of a zipper, the privacy bag 50B features a closure loop 42A, disposed at the top of the bag, through which is threaded a closure cord 44A. In some embodiments, the closure cord 44A is ribbon or cord made of 100% nylon. Once the sex toy is placed inside the privacy bag 50B, the closure cord 44A is pulled such that the closure loop 42A gets smaller and smaller, thus forming a closure around the inside contents.

The privacy bag 50B also features an elongated portion 46 and a form-fitting portion 48. In some embodiments, the privacy bag 50B is eleven inches long and six inches wide, with a three-inch circumference at the elongated portion 46. The privacy bag 50B is thus most suitable for phallic-shaped sex toys such as dildos, although the bag may easily accommodate sex toys of other shapes and sizes.

Because the privacy bag 50B is in an atypical shape, the construction is more complicated, only in the fact that the fabric may be sewn in a non-linear fashion. Again, the interior protective portion 34B and the exterior fabric portion 32B may be cut to a particular shape, representing a desired size of the privacy bag 50A. The two fabric portions 32A and 34A may be laid adjacent to one another, with some portion of the edge around the fabric being sewn together, thus forming a pouch with an open top. The sewn fabric may then be turned inside out, such that the edge seams are on the inside of the pouch. In the privacy bag 50B, a closure loop 42A is additionally sewn into the top of the pouch, with the closure cord 44A then being threaded through the loop. Alternatively, a standard zipper, a series of buttons or snaps, plastic zippers, and other closure means, may be sewn at the top of the bag, enabling the bag to be secured after contents are inserted therein.

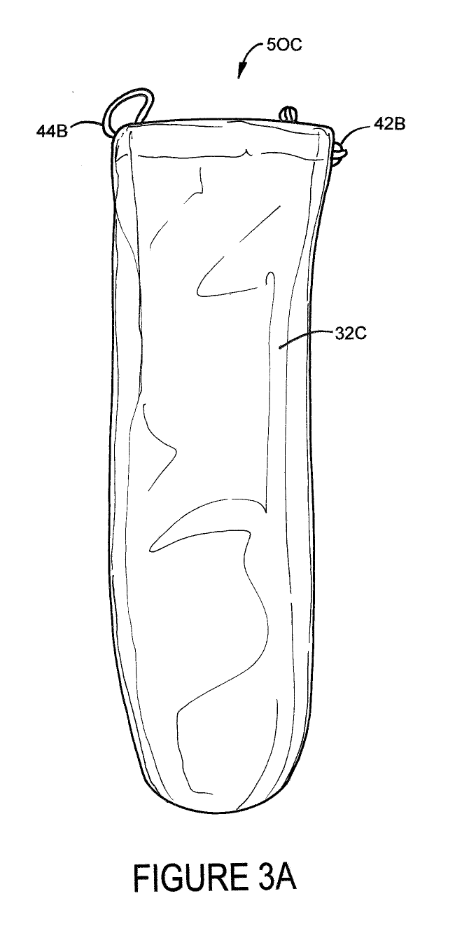

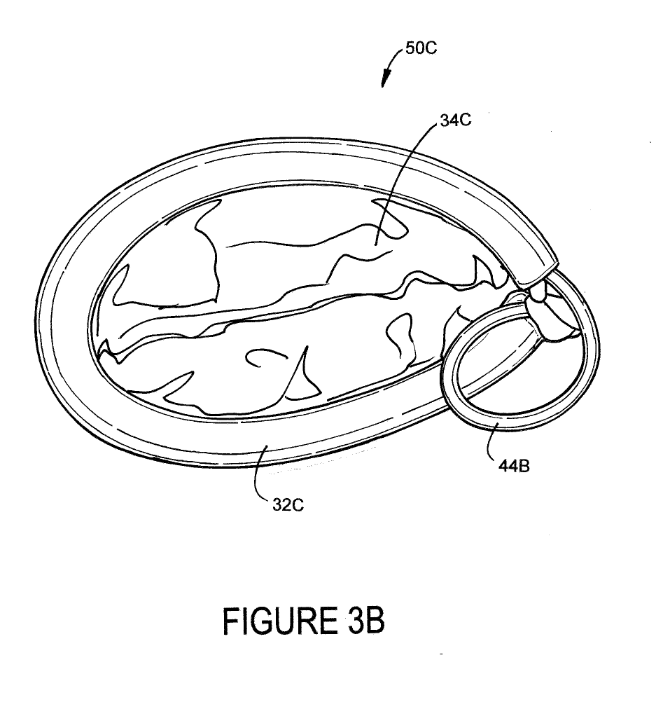

FIGS. 3A and 3B features a third privacy bag 50C, according to some embodiments. Like the privacy bag 50B, the privacy bag 50C may be a sleeve that slides over the sex toy. The privacy bag 50C features a closure loop 42B and closure cord 44B. The exterior fabric portion 32C is made of stretch velvet fabric consisting of 80% polyester and 20% Lycra®, in some embodiments. In other embodiments, the fabric portion 32C consists of polyester and Spandex®, in varying quantities. The interior protective portion 34C consists of HERCULITE®, CHITOSANTE, or another anti-microbial coating, in some embodiments. The shape of the privacy bag 50C is elongated, with no form-fitting portion, as in the privacy bag 50B (FIG. 2). In some embodiments, the privacy bag 50C is 11¼ inches long by 3½ inches wide, thus making the privacy bag suitable for the storage of vibrators and other elongated sex toys.

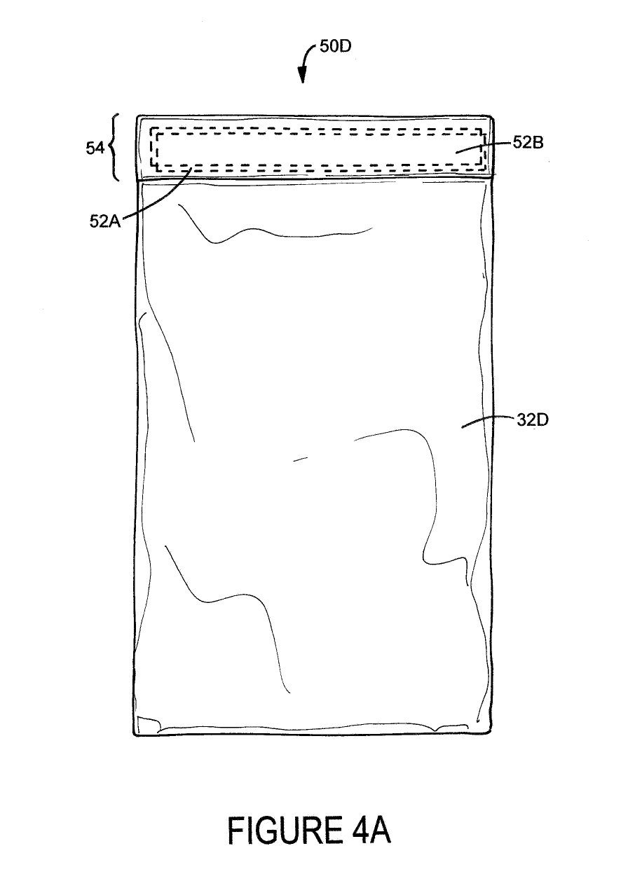

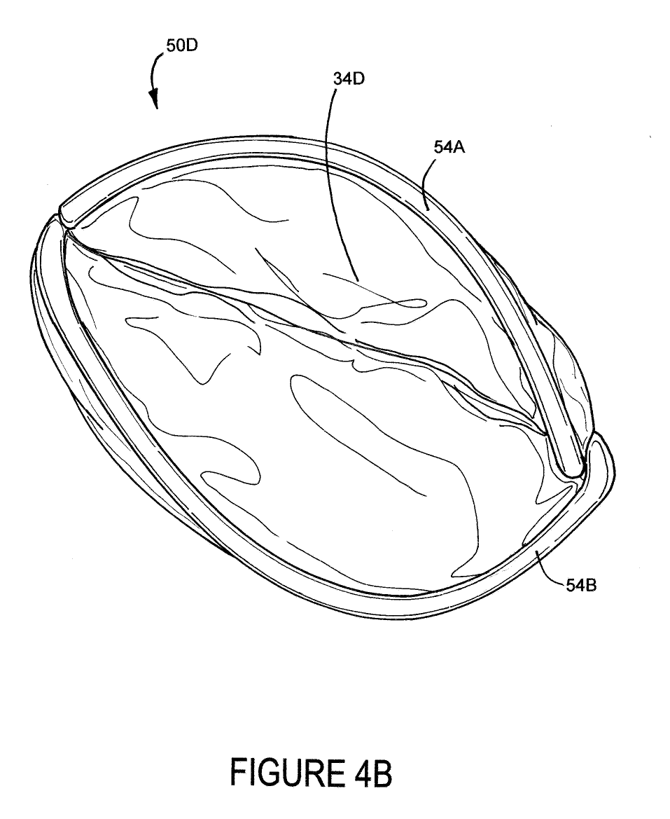

FIGS. 4A and 4B are depictions of a fourth privacy bag 50D, according to some embodiments. The privacy bag 50D features a top portion 54 consisting of an inner top portion 54A and an outer top portion 54B. The inner top portion 54A has disposed inside its fabric a rear magnetic strip 52B while the outer top portion 54B features a front magnetic strip 52A (collectively, “magnetic strips 52”). The magnetic strips are oppositely poled such that they are attracted to one another (i.e., will connect to one another rather than be repelled by one another). The top portion 54 thus is capable of being in an opened position (with the inner protective portion 34D being visible) and in a closed position, with the outer top portion 54B being folded over the inner top portion 54A in the closed position. The magnetic strips 52A and 52B are disposed upon one another in the closed position, thus forming a seal. In contrast to the other privacy bags 50A-50C, the privacy bag 50D defaults to a closed position.

Like the privacy bag 50A, the privacy bag 50D is rectangular in shape, allowing for sex toys of a variety of shapes, as well as lubricants or oils, to be stored therein. In some embodiments, the privacy bag 50D is 6¾ inches long and 4½ inches wide, with the magnetic strips 52 being approximately ½ inch in width. The exterior fabric portion 32D is made up of a polyurethane laminated fabric consisting of 55% polyester knit and 45% polyurethane, in a preferred embodiment. The inner protective portion 34D is made up of Herculite®, Chitosante, or another anti-microbial coating, in some embodiments. The privacy bag 50D also features high-viscosity liquid resistance as well as being spill-proof in some embodiments.

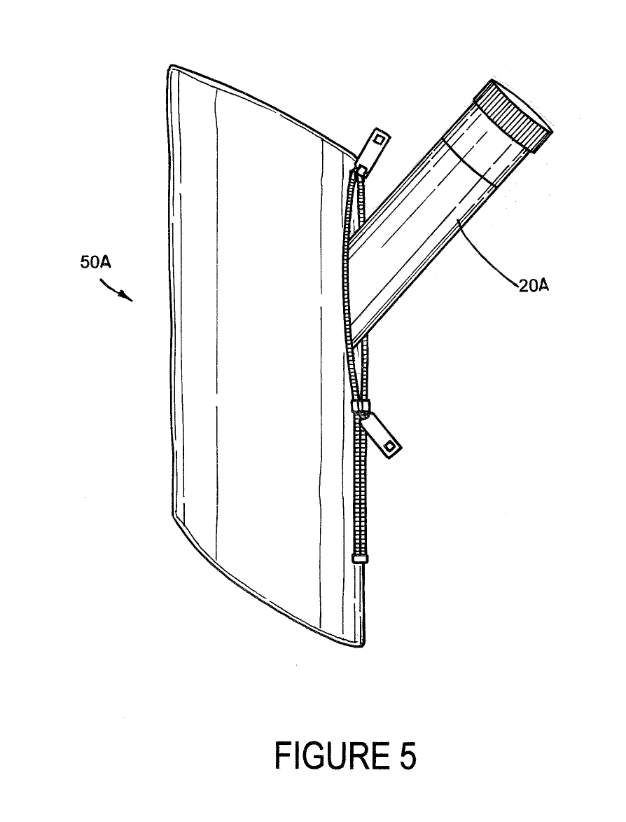

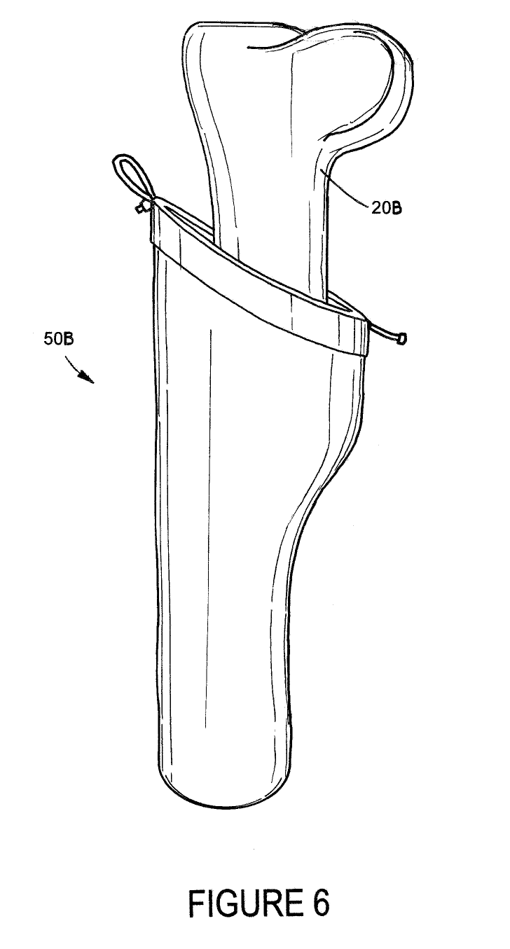

FIGS. 5 and 6 show two privacy bags being used to store sex toys, according to some embodiments. In FIG. 5, the privacy bag 50A is used to store a vibrator 20A while, in FIG. 6, the privacy bag 50B is used to store a dildo 20B. The privacy bags 50 may store any of a variety of different sex toys, including, but not limited to, phallic-shaped sex toys.

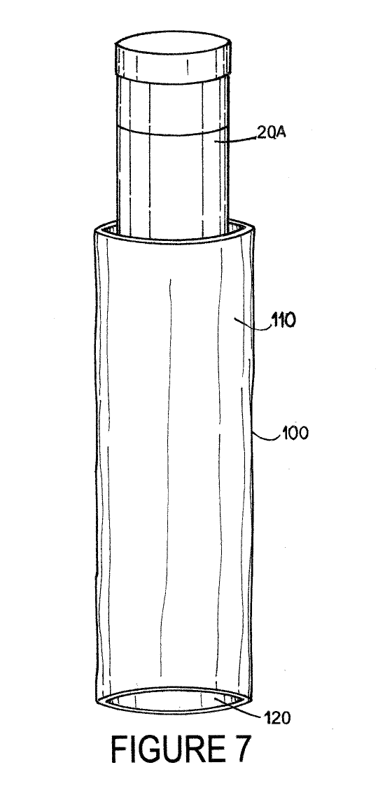

FIG. 7 is a depiction of a privacy sleeve 100, according to some embodiments. Like the previously described privacy bags 50, the privacy sleeve 100 includes an exterior fabric portion 110 and an interior protective portion 120. In FIG. 7, the privacy sleeve 100 assumes a substantially cylindrical shape, opened at both ends of the cylinder.

In some embodiments, the interior protective portion 120 consists of an anti-microbial material, and may further feature anti-static, anti-bacterial, moisture-resistant, and stain-resistant characteristics. In some embodiments, the interior protective portion 120 consists of a HERCULITE® material with a urethane anti-microbial coating. In other embodiments, the interior protective portion 120 consists of CHITOSANTE anti-microbial fabric. Chitosan is a polysaccharide that exhibits antibacterial properties. CHITOSANTE, the fabric made using Chitosan, also exhibits antibacterial, as well as odor-resistant, non-toxic, biodegradable, and other desirable properties. Particularly suited for phallic-shaped sex toys, the privacy sleeve 100 may be slid over the sex toy and thereafter provide the above-described protection to the toy.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. A method to ensure privacy of a sex toy, the method comprising:
inserting the sex toy into an interior protective portion of a privacy bag, the interior protective portion comprising a fabric and a material impregnated in the fabric that protects against the transfer of particulates to the sex toy during storage, the privacy bag further comprising an exterior fabric portion fixably coupled to the interior protective portion, the interior protective portion to obscure the shape of the sex toy;
securing the privacy bag using a zipper, the zipper being disposed along a remaining portion of the privacy bag, the zipper comprising a pair of zipper chains sewn along the remaining portion and at least one pull tab coupled to a slider, wherein the pull tab, once pulled from one side of the remaining portion to another side, cause the pair of zipper chains to interdigitate with one another;
wherein the privacy bag is to be closed for safekeeping of the sex toy.

2. The method of claim 1, further comprising:
locking the privacy bag using the zipper, the zipper further comprising two locking loops, a first locking loop being on the pull tab, wherein the two locking loops fit over one another when the privacy bag is closed, enabling a lock to be threaded through the two locking loops.

3. The method of claim 1, wherein the material impregnated in the fabric comprises HERCULITE®.

4. The method of claim 1, wherein the material impregnated in the fabric comprises CHITOSANTE.

5. A method to protect a sex toy from being viewed unintentionally, the method comprising:
inserting the sex toy into an interior protective portion of a privacy bag, the privacy bag comprising a predefined shape, the interior protective portion comprising a fabric and a material impregnated in the fabric that protects against the transfer of particulates to the sex toy during storage, the privacy bag further comprising an exterior fabric portion fixably coupled to the interior protective portion, the interior protective portion to obscure the shape of the sex toy;
securing the privacy bag using a closure loop at an opening of the privacy bag, wherein a closure cord is threaded through the closure loop;
wherein the privacy bag is secured in a closed position by pulling on the closure cord such that the fabric gathers together.

6. The method of claim 5, the inserting step further comprising:
inserting the sex toy into the interior protective portion of the privacy bag, the privacy bag, wherein the predefined shape is a rectangle.

7. The method of claim 5, the inserting step further comprising:
inserting the sex toy into the interior protective portion of the privacy bag, the privacy bag, wherein the predefined shape is an elongated rectangle.

8. The method of claim 5, the inserting step further comprising:
inserting the sex toy into the interior protective portion of the privacy bag, the privacy bag, wherein the predefined shape is as shown in FIG. 2.

9. A method to protect a sex toy from being viewed unintentionally, the method comprising:
inserting the sex toy into a privacy bag comprising a rectangular shape, an interior protective portion, and an exterior fabric portion, wherein the interior protective portion comprises a fabric that protects against the transfer of microbes to the sex toy while inserted into the privacy bag; and
securing the sex toy inside the privacy bag using a closure mechanism disposed along an opening of the privacy bag, the fourth side having an inner top portion and an outer top portion, the closure mechanism further comprising:
a first magnetic strip sewn inside a first portion of the opening; and
a second magnetic strip sewn inside a second portion of the opening, wherein the first magnetic strip and the second magnetic strip are oppositely poled;
wherein the privacy bag is secured by folding the first portion over the second portion such that the first magnetic strip and the second magnetic strip are fixably engaged.

10. The method of claim 9, the inserting step further comprising:
inserting the sex toy into the privacy bag wherein the material impregnated in the fabric is oil-resistant.

11. The method of claim 9, the inserting step further comprising:
inserting the sex toy into the privacy bag, wherein the material impregnated in the fabric is Herculite®.

12. The method of claim 9, the inserting step further comprising:
inserting the sex toy into the privacy bag, wherein the material impregnated in the fabric is allergen-resistant.
